(19) United States
(12) Patent Application Publication
(10) Pub. No.: US 2005/0144555 A1
(43) Pub. Date: Jun. 30, 2005

(54) Method, system, computer program product and storage device for displaying a document

(75) Inventor: Steven Morris, Taipei (TW)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/510,788

(22) PCT Filed: Mar. 19, 2003
(86) PCT No.: PCT/IB03/01013

(30) Foreign Application Priority Data
Apr. 15, 2002 (EP) 02076460.1

(51) Int. Cl. G06F 17/00

(52) U.S. Cl. 715/513

(57) ABSTRACT

Handheld display devices have often limited display capabilities. In order to view a full HTML page (200), a method is provided that splits the original page into less complex units (210, 206, 208, 204, 212, 214, 202) so that they can be best displayed on these small devices. The document is parsed into a tree structure and the complexity of the tree is calculated. Depending on the complexity it is decided which part of the document must be displayed onto a new page.

The invention relates to a method of displaying a structured document comprising the steps of:
loading the structured document;
parsing the structured document into a hierarchical structure.

The invention further relates to a system to display a structured document, the system comprising:
loading means conceived to load the structured document;
parsing means conceived to parse the structured document into a hierarchical structure.

The invention further relates to a computer program product comprising program code means designed to perform such method.

The invention further relates to a storage device comprising such computer program product.

An embodiment of such a method is known from U.S. Pat. No. 5,987,256. Here a method is described for processing an object specified by an object specifying language such as HTML, JAVA. Also other specifying languages can be used, that rely on relative positioning that requires a rendering program. This rendering program utilizes a minimum set of resources and translates the code for use in a target device that has limited processing resources. These limited processing resources are unsuited for storage and execution of the HTML rendering program, JAVA virtual machine, or other rendering engine. Data concerning such an object is generated by a process that includes first receiving a data set specifying language, translating the first data set into a second data set in an intermediate object language adapted for a second rendering program suitable for rendering by the target device that utilizes actual target display coordinates. The second data set is stored in a machine readable storage device, for later retrieval and execution by the thin client platform. Upon loading, for example an HTML file, into the translating device, information concerning the target device is loaded. The HTML file is then parsed by searching for HTML tags, and based on such tags creating a hierarchical structure. Using the parameters of the target device, and the hierarchical structure, the method performs HTML rendering based on a hierarchy adapted to the dimensions and palette of the target device. This determines the coordinates of all the graphic objects specified by the HTML code on the screen of the target device. For example, the paragraphs are word wrapped, horizontal rules are placed in particular places, the colors are chosen, and other device specific processes are executed.

It is an object of the invention to provide a method according to the preamble that enables a more flexible adaptation of the contents of a document to display dimensions. To achieve this object the method is characterized in that the method further comprises the steps of:
calculating a complexity of the hierarchical structure;
traversing the hierarchical structure; and
conditionally displaying a part of the structured document depending on the complexity of a traversed part of the hierarchical structure.

By parsing a structured document into a hierarchical structure, for example a Document Object Model tree (DOM) tree, the structured document is subdivided into less complex units. The complexity of this tree structure can then be calculated by calculating the complexity of the units. The complexity of a node of the tree is a measure of the size of the node, preferably including the size of the sub-tree of the node. This size can depend for example on the kind of the unit, like a paragraph or a table, and the amount of document space the unit requires. By using this complexity of a node during traversal of the tree, it is decided on-the-fly if a node and its sub-tree can be comprehensively displayed on a displaying device.

An embodiment of the method according to the invention is described in claim 2. By comparing the complexity of a node with its sub-tree, to a predefined threshold, the parts of the document that can be displayed comprehensively to a user can be determined easily. The threshold can depend on the display dimensions of a display device. The threshold can also depend on user preferences or for example font size used.

An embodiment of the method according to the invention is described in claim 3. By adding a reference to the part of the document that is to be displayed on a separate page, the user does not loose the context of the content of the total document. The user is provided with a common user interface, for example a uniform resource locator (URL), that references the part of the document that is displayed on a separate page.

An embodiment of the method according to the invention is described in claim 4. By dividing the document into elements that are less complex units, the properties of each element can be taken into account to determine the complexity of an element. For example a table element is more complex than a paragraph element, since additional space is required for table borders and cell boundaries. This leads to a higher complexity number for a table than for a paragraph. By taking these complexity numbers into account, it can be decided better if a part of a document can still be displayed on one page by the display device.

It is a further object of the invention to provide a system according to the preamble that enables a more flexible adaptation of the contents of a document to display dimensions. In order to achieve this object, the system is characterized in that the system further comprises:
calculating means conceived to calculate a complexity of the hierarchical structure;
traversing means conceived to traverse the hierarchical structure; and
displaying means conceived to conditionally display a part of the structured document depending on the complexity of a traversed part of the hierarchical structure.

It is a further object of the invention to provide a computer program code means and a storage device that enables a more flexible adaptation of the contents of a document to display dimensions. In order to achieve this object, the program code means is designed to perform the method according to the invention and the storage device comprises the computer program product according to the invention.

The invention will be described by means of embodiments illustrated by the following drawings

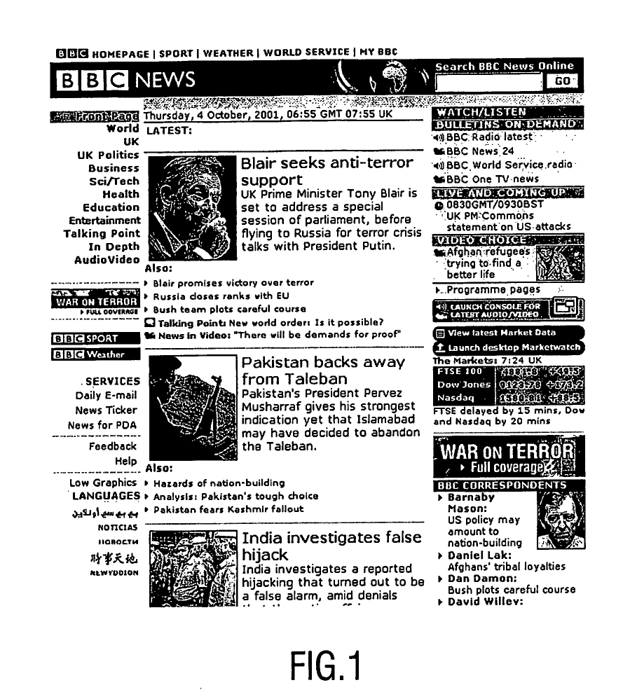

FIG. 1 illustrates a BBC news site;

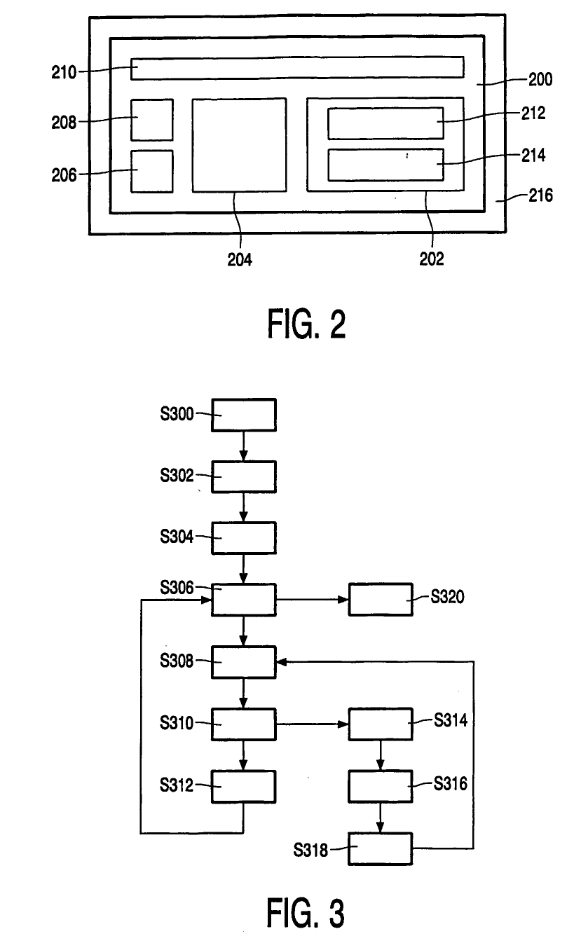

FIG. 2 illustrates an example of a schematic table layout;

FIG. 3 illustrates the main steps of the method according to the invention in a schematic way;

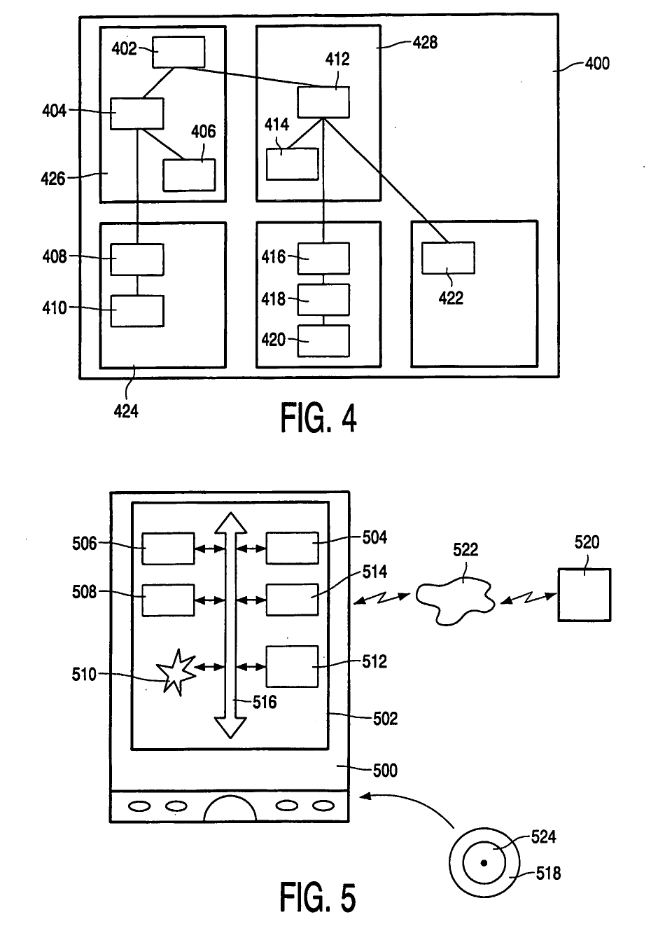

FIG. 4 illustrates an example of a partitioning of a table hierarchy comprised within a page;

FIG. 5 illustrates the main parts of a device comprising a system according to the invention in a schematic way.

More and more devices are becoming internet-enabled, and the number is only expected to grow in the future. As internet access becomes more ubiquitous, and the devices that provide this access become more mobile, the size of the display that most people use to view internet content will reduce. At present, most internet content is authored to look its best on larger display devices such as computer monitors. Even when displayed on a screen that is relatively large for a mobile device, such as a personal digital assistant (PDA) screen, the usability of content can drop dramatically. A number of factors, such as page complexity, navigational aids and the suitability of content affect the usability of internet content. One of the most common themes is simplicity of design and document structure. This is even more important on a mobile device. For instance, a typical browser running on a PC may have a window size of 800×600 pixels for viewing content. This does not include other screen real estate used by a web browser for menus, toolbars and other features. Even on a high-end mobile device, cost and practicality issues limit the total screen size of 320×240 pixels at present. Mobile phones may even have a display that is only 100 pixels square. Attempting to display a conventional web page that has been authored for a large screen on a small device causes problems to the user because so little of the page is visible on screen at once. Thus, the user loses the context of where they are on the page, and the navigational complexity of the page is increased. This causes problems for web authors wishing to target mobile devices, because the mobile devices have usability requirements far different from conventional desktop PCs.

Current services for mobile devices, such as Wireless Applications Protocol (WAP) or I-mode solve this problem by using markup languages that are subsets of HTML functionality as defined by the World Wide Web Consortium (W3C). In the case of WAP, this is a very different markup language with additional structural features that are used to improve navigation (the “deck of cards’ metaphor in WAP). I-mode uses a cut-down version of HTML with much of the functionality removed. In both cases, content must be re-authored or authored in a common format and automatically adapted for use on one or more device types, which can lead to errors, inconsistencies and increased maintenance effort. The overall effect of this is that content is primarily published for one device type.

Tables are often used, by web site designers, to provide control over formatting a Web page that HTML was never intended to provide. Rationales for this can be:
to provide consistent look-and-feel across different web browsers;
to comply with house style rules aimed at printed material rather than web-based material;
to enable stylistic effects that would not be possible otherwise; or to provide a way of grouping certain elements on a page in a way that fits with a house style.

FIG. 1 illustrates the BBC news site http://news.bbc.co.uk. This news site uses eleven tables, nested up to four deep, to maintain their layout. The illustration shows approximately half of the page contents—even on a high-resolution PC display, the user must scroll to see a large portion of the page. The content is roughly three times wider and four times taller than the display on a high-end mobile device. This is a high level of complexity, and is very common amongst web sites.

This level of complexity cannot be displayed easily on a small display device, and for this reason usability is greatly affected. The user both loses context about where they are on the page, and is forced to perform more user interface operations, like clicking, scrolling, etc. to find the information that they want to see. Providing context and reducing the need for user interaction can improve the usability. Techniques such as scaling images and summarizing text are useful aids in usability, but in cases like those illustrated above, the inherent complexity of the document decreases its usability on a device with a small display. A way to improve the usability is to reduce this inherent complexity.

FIG. 2 illustrates an example of a schematic table layout. The container table 200 comprises sub-tables 202, 204, 206, 208, and 210. The sub-table 202 comprises sub-sub tables 212 and 214. In order to reduce the complexity of container table 200, a proxy server implements the method according to the invention. A proxy server is a well-known and commonly used mechanism for allowing devices to access internet content. Proxy servers take requests for internet content and pass these requests on to the server that actually contains the content, passing the returned content on to the requesting client. For instance, this is used to provide internet access through firewalls, or to adapt content before it is sent to a client. The proxy server that implements the method according to the invention modifies the contents of for example an HTML document to reduce the complexity of a web page. Documents that adhere to other formats like XML, XHTML, etc. can also be modified to reduce the complexity of the page.

The container table 200 is displayed on a web page 216. By removing, for example, the sub table 202 tables from the main page 216, the complexity of the page 216 is reduced and the page becomes easier to navigate. Reducing the complexity of the page 216 is performed in two main ways:
page breaks are inserted in long pages to reduce the amount of content on each page; and
nested tables may be placed on separate pages, depending on their complexity. The use of tables for formatting enables a web page to be split into coherent sections which can be placed on separate pages, with hyperlinks to those sections instead of the original content. A page with many nested tables can be considered as a tree structure, where each nested table consists of a node in the tree. It is possible to limit the complexity of the contents of a web page by partitioning this tree.

FIG. 3 illustrates the main steps of the method according to the invention in a schematic way. Step S300 is an initialization step within which the proxy server receives the document. Within step S302, the proxy server parses the document and creates a parse tree for it. The created parse tree adheres to the Document Object Model (DOM). DOM is a programming interface specification developed by the World Wide Web Consortium. However, the parse tree can also be a less detailed tree that is constructed by a stream-based HTML parser. This stream-based HTML parser searches for the special HTML tags and creates a more simple tree based on these special HTML tags. The stream-based parser, parses the page into its component page elements. These are individual parts of a page that affect the overall structure and formatting of a page, not just of an individual piece of text. The following are considered as separate page elements: paragraphs, tables, lists, preformatted text, images, forms, Java applets.

Within the next step S304, the complexity of each element in the document is calculated. The complexity of each page element is measured as the size of its displayable content, i.e. graphical elements that are actually displayed on the screen, multiplied by a weighing factor to account for the complexity introduced by the page element itself. For example, a table is more complex than a simple paragraph, since extra space is required for table borders and cell boundaries, and so its weighting factor is higher. Some page elements such as lists, forms and tables may contain nested page elements e.g. images or multiple paragraphs within a list entry, and so the complexity of these nested table elements is added to the complexity of the page element that includes them. This complexity value is a property of the document itself, in stead of a property of the display device. Effectively, it is a measure of the size of the document tree, where the “size” of each node may vary with the type of the node. Only a threshold value, as described below, varies with the display size or other external factor. For example, consider the page as illustrated within FIG. 4. Then the complexity is measured as follows. First the complexity measure of the list, referred to as m in this example, is taken. Then, an additional complexity factor is added for each of the two list entries, and is referred to as n. Thus, the complexity measure for the list and its structure is
(m+2n)
This only considers the complexity of the list structure itself. Thus only, the effect of horizontal and vertical spacing required to separate the list from the surrounding text, and to separate each element. It does not consider the complexity of the actual contents of the list. The complexity of the actual contents of the list is calculated separately, and the complexity of the list entries and the list structure are summed to give a total complexity measure for the list. Once the complexity of the list structure itself is calculated, the complexity of the page elements making up each list entry is considered. The first entry consists of two paragraphs. For each paragraph, the complexity is taken to be a constant weighing factor p multiplied by the length in characters of the displayable text in the paragraph. Thus, the complexity of the first list entry as a whole can be considered to be
p(para₁+para₂)
where para₁ and para₂ are the length of the first and second paragraphs respectively. The second list entry comprises of one paragraph of text and its complexity is measured as described above. It also comprises an image, whose complexity is measured as a weighting factor i, multiplied by its area a. This gives a measure of complexity for this list element as
p(para₃)+ia
Thus, the complexity of the entire list can be calculated as
(m+2n)+(p(para₁+para₂))+(p(para₃)+ia)

The complexity of a table is measured as the sum of the complexity of all cells in the table, multiplied by a weighing factor consisting of a base weighting factor for the table t multiplied by a weighted value for the number of rows (W_{rows}) and a weighted value for the number of columns (w_{columns}):

$${tw}_{rows} {w}_{columns} ( {\sum }_{{cell}_{0}}^{{cell}_{max}} complexity ( {cell}_{n} ) )$$

The value of the weighting factor for rows and columns is constant for each table. Other contributions to this value, like cell spacing, padding and border size, are set as part of the whole element and not on a per-cell basis. Therefore, these contributions are not taken into account for calculating the value of the weighting factor for rows and columns and these weighting factors are calculated once for each table.

The complexity of nested tables is not taken into account when calculating the complexity of a table. Since the purpose of calculating the complexity of a table is to partition the table in to sub-trees based on this complexity measure, the complexity of each node in the tree must not include the complexity of any child nodes since these child nodes may not appear on the same page when the tree is partitioned, and thus will not contribute to its complexity in that situation.

Within step S306 a node of the parse tree is considered such that the parse tree is traversed in a depth-first manner. Within the next step S308, the complexity of the node is added to the current complexity count. This current complexity count is compared to a threshold within step S310. The threshold value depends on a number of, non-limiting properties, like the display resolution, font size and user preferences. If the current complexity count is below the threshold, the node, or page element is written to the current page within step S312. If the current complexity count is greater than the threshold, the method proceeds to step S314. Within step S314, a new page is created and the current complexity count is reset. Within the next step S316, a hyperlink, like a unified resource locator or URL, to the new page is inserted into the current, old, page and the method proceeds to step S308. Now, within step S308, the current page considered is the new page. If the page element is written to a page, the method proceeds to step S306 and considers the next node. When there are no more nodes to traverse the method proceeds to step S320 and stops.

For an HTML table, the method proceeds slightly different. When a table is written to the adapted page, the contents of each cell is written out one cell at a time by traversing the document tree in a depth-first manner. If, in the course of processing that table, a nested table is encountered and is too complex to be placed on the current page, the current page and its complexity count is pushed on to a stack of currently open pages. A new page is created for the nested table, and a hyperlink to it is added to the current cell of the current page. The nested table is then written to the new page. Once the nested table has been completely written, the page is closed, and the old page is popped from the stack, so that the remainder of the original table can be written. This is a recursive operation, since tables may be nested to an arbitrary depth.

In pseudo-code, the method for writing the adapted table is as follows:

```
function write_table(
    paragraphElement table
) {
    complexity_count = complexity_count +
        table.table_complexity
    if (complexity_count > threshold_value) {
        create_new_page
        add_hyperlink_to(new page)
        push(current_page, complexity_count)
        current_page = new_page
    }
    for each cell c in current_table {
        for each paragraph element pe in c {
            if (pe is a table) {
                write_table(pe)
            } else {
            write_paragraph_element(pe)
            }
        }
    }
    if (
        (table_is_root_table_on_current_page) and
        not (table_is_root_of_table_hierarchy)
    ) {
        pop(current_page, complexity_count)
    }
}
function write_paragraph_element(
    paragraphElement pe
) {
    if (pe is list) {
        write_list(pe)
    } else if (pe is paragraph) {
        write_paragraph(pe)
    } else if (pe is table) {
        write_table(pe)
    } else
    ...
}
```

FIG. 4 illustrates an example of a partitioning of a table hierarchy comprised within a page 400. The tables are numbered in the order that they would be processed, showing that the software traverses the table hierarchy in a depth-first manner. This is consistent with writing every table as they are encountered in the HTML source. Tables 402 and 404 are both fairly simple, and can be written on to the same page. However, table 408 is too complex to be written at a third level of nesting on the current page 426. The method according to the invention creates a new page 424, and writes table 408 onto that page 424. In doing so, the method encounters table 410, which is simple enough to be written to the same page 424. After completing table 410, and the remaining cells in table 408, the method finishes the current page 424 and returns to the previous page 426 and continues to write table 404. When table 406 is encountered, it is simple enough to fit on the same page as tables 402 and 404. After completing the processing of table 404, the method encounters table 412. This is sufficiently complex to require a new page 428. This process is continued for all other sub-tables in the hierarchy.

The method according to the invention is described with reference to HTML pages. However, the method is not limited to HTML pages, but can be also applied to pages based on other hierarchical oriented languages as defined by the W3C, like, for example, XML, XHTML, RDF etc. without departing from the design principles of the current method.

FIG. 5 illustrates the main parts of a device 500 comprising the system 502 according to the current invention in a schematic way. The system 502 comprises computer readable code 506 that is designed to load the HTML document. The system further comprises computer readable code 504 that is designed to parse the HTML document into a document tree structure as previously described. The computer readable code 508 is designed to calculate the complexity of the HTML document whereas the computer readable code 514 is designed to traverse the document tree in a depth-first manor to decide if a page element is to be displayed on the current or on a next, newly created page. The computer readable code 512 is designed to display the current and newly created pages onto the display of the device 500. The computer readable code is comprised within a general purpose memory that communicates with the central processing unit 510 through software bus 516. The device 500 is a personal digital assistant (PDA), but can be any handheld display device like a mobile phone or the like that has limited display capabilities. The device can also be a set-top box or a digital television receiver. The device 500 has a wire-less connection to the internet 522. The document that the device receives is comprised onto a server 520. The document can be accessed by the device through the internet 522. The connections between the server 520 and internet 522 is wire-less. Both connections can also be wired. The previously mentioned computer readable code that is designed to perform the method according to the invention can be downloaded from the internet 522 to the device 500. It can also be downloaded from a computer readable medium like a compact disk 518 that comprises the computer readable code 524 that is designed to perform the method according to the invention. In the latter case, the device 500 comprises an appropriate reading device like a compact disk reader.

1. Method of displaying a structured document comprising the steps of:
loading the structured document;
parsing the structured document into a hierarchical structure characterized in that the method further comprises the steps of:
calculating a complexity of the hierarchical structure;
traversing the hierarchical structure; and
conditionally displaying a part of the structured document depending on the complexity of a traversed part of the hierarchical structure.

2. Method of displaying a structured document comprising according to claim 1, wherein the complexity is compared with a predetermined threshold to determine a first part of the document to be displayed on a first page and a second part of the document to be displayed on a next page.

3. Method of displaying a structured document comprising according to claim 2, the method further comprising adding a reference to the first page to enable navigation to the second part of the document.

4. Method of displaying a structured document according to claim 1, wherein the document comprises elements that contribute to the hierarchical structure and a property of each element is used to calculate the complexity of the hierarchical structure.

5. System to display a structured document, the system comprising:
loading means conceived to load the structured document;
parsing means conceived to parse the structured document into a hierarchical structure
characterized in that the system further comprises:
calculating means conceived to calculate a complexity of the hierarchical structure;
traversing means conceived to traverse the hierarchical structure; and
displaying means conceived to conditionally display a part of the structured document depending on the complexity of a traversed part of the hierarchical structure.

6. Computer program product comprising program code means designed to perform the method according to claim 1.

7. Storage device comprising the computer program product according to claim 6.
